(19) United States
(12) Patent Application Publication
(10) Pub. No.: US 2016/0321578 A1
(43) Pub. Date: Nov. 3, 2016

(54) SYSTEM AND METHOD FOR VERIFYING ENTERPRISE RESOURCE PLANNING DATA

(71) Applicant: Vatbox, Ltd., Herzeliya (IL)

(72) Inventors: Isaac SAFT, Kfar Neter (IL); Noam GUZMAN, Ramat Hasharon (IL)

(73) Assignee: Vatbox, Ltd., Herzeliya (IL)

(21) Appl. No.: 15/140,946

(22) Filed: Apr. 28, 2016

Related U.S. Application Data
(60) Provisional application No. 62/156,201, filed on May 2, 2015.

(51) Int. Cl. G06Q 10/06; G06K 9/00; G06F 17/30

(52) U.S. Cl. CPC G06Q 10/0631; G06F 17/30634; G06F 17/30722; G06K 9/00442; G06K 2209/01

(57) ABSTRACT

A system and method for verifying enterprise resource planning data. The method includes analyzing, via an optical recognition processor, an unstructured data set; generating, based on the analysis of the unstructured data set, metadata; identifying a report including at least partially structured data corresponding to the unstructured data set; analyzing, based on the metadata, the identified report to determine whether the unstructured data set matches the identified report; and determining that the unstructured data set is verified, when it is determined that the unstructured data set matches the identified report.

### CROSS-REFERENCE TO RELATED APPLICATIONS

This application claims the benefit of U.S. Provisional Application No. 62/156,201 filed on May 2, 2015, the contents of which are hereby incorporated by reference.

### TECHNICAL FIELD

The present disclosure relates generally to receipt analytics systems, and more specifically to verifying data generated by enterprise resource planning systems.

### BACKGROUND

Enterprise resource planning (ERP) is business management software typically used to collect, store, manage, and interpret data from various business activities such as, for example, expenses made by employees of an enterprise. ERP systems generally collect data related to business activities of various departments in an enterprise. Such collected data may come from different data sources and/or may be in different formats. ERP systems provide an integrated view of this business activity data, and further enable generation of expense reports that can later be sent to the relevant tax authority.

Especially in large enterprises, employees engage in a high number of business activities. Such business activities may further result in a large number of business expenses to be reported to tax authorities. Reporting such business expenses may result in tax breaks and/or refunds. To this end, employees typically provide receipts based on expenses incurred and are usually required to indicate the types of such expenses. Based on the indication, an ERP system may generate a report which is provided with any received receipts to the relevant tax authority.

Additionally, pursuant to managing the data related to business activities, ERP systems must associate and track relations between sets of the managed data. For example, information related to tax reporting of a receipt must be maintained with an association to the receipt itself. Any errors in associations between data sets can result in incorrect reporting, which in turn may cause loss of profits due to unsuccessful redemptions and exemptions, and/or failure to comply with laws and regulations. Thus, accurate data management is crucial for ERP systems.

Tracking such data presents additional challenges when portions of the data are unstructured. For example, there are further difficulties associated with tracking expense receipts stored as image files. Some existing solutions to these challenges involve identifying contents of files containing unstructured data based on file extension names provided by users. Such solutions are subject to human error (e.g., typos, mistaking contents of files, etc.), and may not fully describe the contents therein. These disadvantages may further contribute to inaccuracies in ERP systems.

The number of receipts obtained by employees in the course of business may be tremendous. This high number of receipts results in significant increases in data provided to ERP systems, thereby leading to difficulties managing the data in such ERP systems. Specifically, existing solutions face challenges in maintaining correct associations within the managed data. These difficulties may result in errors and mismatches. When the errors and mismatches are not caught in time, the result may be false or otherwise incorrect reporting. Manually verifying that reports match receipts is time and labor intensive, and is subject to human error. Further, such manual verification does not, on its own, correct issues with the managed data.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for verifying enterprise resource planning data. The method comprises analyzing, via an optical recognition processor, an unstructured data set; generating, based on the analysis of the unstructured data set, metadata; identifying a report including at least partially structured data corresponding to the unstructured data set; analyzing, based on the metadata, the identified report to determine whether the unstructured data set matches the identified report; and determining that the unstructured data set is verified, when it is determined that the unstructured data set matches the identified report.

The disclosed embodiments also include a system for verifying enterprise resource planning data. The system comprises an optical recognition processor for analyzing unstructured data; a processing unit; and a memory, the memory containing instructions that, when executed by the processing unit, configure the system to: analyze, by the optical recognition processor, an unstructured data set; generate metadata based on the unstructured data set; identify a report including at least partially structured data corresponding to the unstructured data set; analyze, based on the metadata, the identified report to determine whether the unstructured data set matches the identified report; and determine that the unstructured data set is verified, when it is determined that the unstructured data set matches the identified report.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for verifying enterprise resource planning data according to an embodiment.

FIG. 3 is a flowchart illustrating a method for generating metadata for an activity according to an embodiment.

FIG. 4 is a block diagram of a verification system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for verifying enterprise resource planning data. Unstructured data is analyzed to generate metadata respective thereof. A report stored in an enterprise resource planning system and corresponding to the analyzed unstructured data is identified based on the metadata. The identified report is analyzed with respect to the metadata to verify the relationship between the report and the image. If there is a mismatch, a notification regarding the error may be generated and sent.

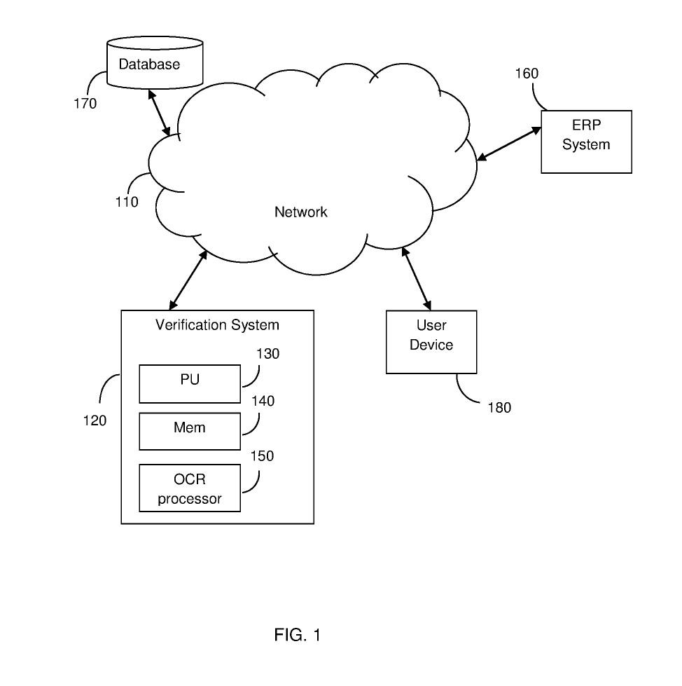

FIG. 1 shows an example network diagram 100 utilized to describe the various disclosed embodiments. The network diagram 100 includes a verification system 120, an enterprise resource planning (ERP) system 160, a database 170, and a user device 180 communicatively connected via a network 110. The network may be, but is not limited to, a wireless, cellular or wired network, a local area network (LAN), a wide area network (WAN), a metro area network (MAN), the Internet, the worldwide web (WWW), similar networks, and any combination thereof.

The user device 180 may be, but is not limited to, a personal computer, a laptop, a tablet computer, a smartphone, a wearable computing device, or any other device capable of capturing, storing, and/or sending unstructured data sets. As a non-limiting example, the user device 180 may be a smart phone including a camera. The user device 180 may be utilized by, for example, an employee of an organization associated with the enterprise resource planning system 160.

In an embodiment, the verification system 120 includes an optical recognition processor 150. The optical recognition processor 150 is configured to identify at least characters and/or other visual features in data and, in particular, in unstructured data. In an embodiment, the verification system 120 is configured to receive an image (e.g., image of expense receipts) or any other unstructured data set from the enterprise resource planning system 160. The unstructured data may be provided to the enterprise resource planning system 160 by, e.g., a user of the user device 180. For example, a user of the user device 160 may take a picture of a receipt via a camera of the user device 180 and send the picture to the enterprise resource planning system 160. The unstructured data set is analyzed by the optical character recognition processor 150. The analysis may include, but is not limited to, recognizing elements shown in the unstructured data set via computer vision techniques. Such computer vision techniques may further include image recognition, pattern recognition, signal processing, character recognition, and the like.

Based on the analysis, the verification system 120 may be configured to generate metadata for an activity (e.g., a business activity such as an expense). The metadata may include, but is not limited to, characters and/or strings associated with an activity. As an example, for a purchase activity resulting in incurring an expense, the metadata may include a location in which the expense was incurred, characteristics of the place of business in which the expense was made (e.g., type of business, types of products sold, etc.), a time at which the expense was incurred, an amount (e.g., a dollar amount or an amount in any other currency), combinations thereof, and the like. The optical character recognition processor 150 sends the metadata to the verification system 120.

The verification system 120 is configured to receive the metadata from the optical character recognition processor 150 and to identify a report in the ERP system 160 based on the receipt. Reports in the ERP system 160 are typically electronic documents that may be, for example, manually filled in by an employee (by, e.g., typing or otherwise inputting information). Each report may include structured and/or semi-structured data (hereinafter “structured data”). In an embodiment, the structured and/or semi-structured data includes data included in fixed fields within the report. Specifically, identifying the report may include analyzing reports in the ERP system 160 to identify structured data therein, and determining which unstructured data sets in the ERP system 160 include unstructured data corresponding to any of the identified structured data.

In an embodiment, the report may be identified by comparing the structured data of the report to the metadata. Specifically, a query may be generated based on the metadata and utilized to search a database for the report. The comparison may include, but is not limited to, matching the structured data in the identified report to the metadata. The matching may be based on, e.g., a predetermined threshold. If it is determined that the identified report structured data matches the metadata, the report is verified. If it is determined that there is a mismatch (i.e., the identified report structured data does not match the metadata), a notification regarding the mismatch may be generated and sent to, e.g., the user device 180.

The verification system 120 typically includes a processing unit (PU) 130 coupled to a memory (mem) 140. The processing unit 130 may comprise or be a component of a processor (not shown) or an array of processors coupled to the memory 140. The memory 140 contains instructions that can be executed by the processing unit 130. The instructions, when executed by the processing unit 130, cause the processing unit 130 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be understood that the embodiments disclosed herein are not limited to the specific architecture illustrated in FIG. 1, and other architectures may be equally used without departing from the scope of the disclosed embodiments. Specifically, the verification system 120 may reside in a cloud computing platform, a datacenter, and the like. Moreover, in an embodiment, there may be a plurality of verification systems operating as described hereinabove and configured to either have one as a standby, to share the load between them, or to split the functions between them. Additionally, in some embodiments, the optical character recognition processor 150 may be integrated in the verification system 120. Further, the embodiment discussed with respect to FIG. 1 is described as interacting with only one enterprise resource planning system 160 merely for simplicity purposes and without limitations on the disclosure. Data from additional enterprise resource planning systems may be verified by the verification system 120 without departing from the scope of the disclosed embodiments.

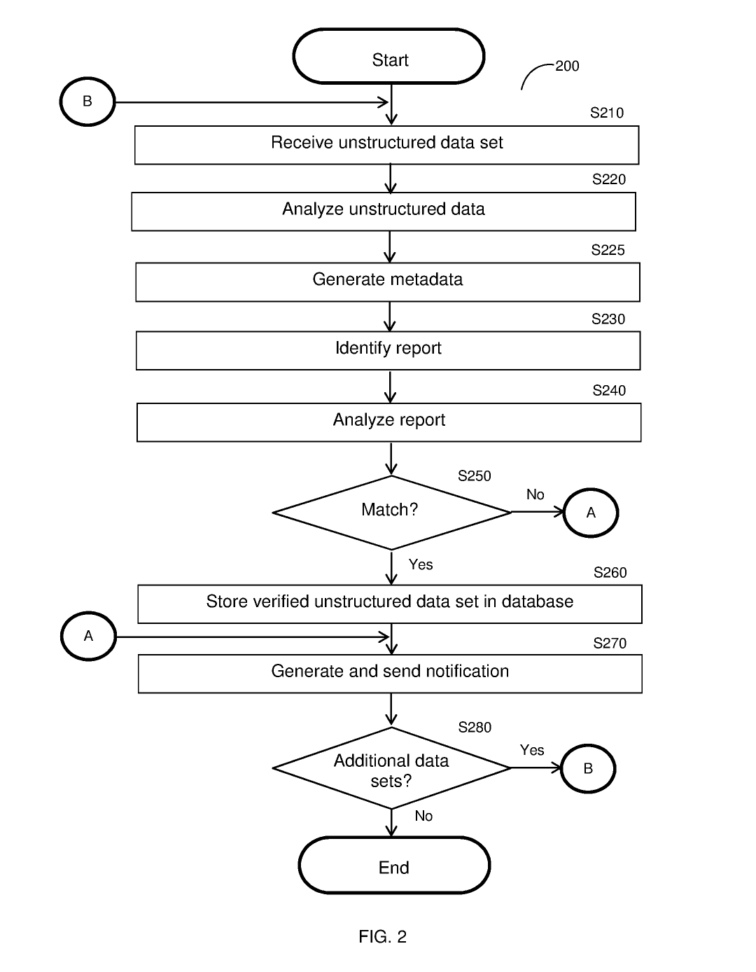

FIG. 2 is an example flowchart 200 illustrating a method for verifying data in an ERP system according to an embodiment. In an embodiment, the method may be performed by a verification system (e.g., the verification system 120).

At S210, an unstructured data set related to an activity for which a report may have been generated is received or retrieved. In an embodiment, the unstructured data set may be retrieved from an enterprise resource planning (ERP) system (e.g., the ERP system 160). In another embodiment, the unstructured data may be received from, e.g., a user device. For example, the unstructured data may be received from a mobile device operated by an employee of an organization. The unstructured data set may include, but is not limited to, images. The images may further include pictures of receipts of expenses related to business activities. As an example, the received unstructured data may be an image of a receipt based on a purchase of office supplies made by an employee. The image may be captured via a camera of a smart phone operated by the employee.

At S220, the unstructured data is analyzed. In an embodiment, the unstructured data may be analyzed via an optical character recognition (OCR) processor (e.g., the OCR processor 150). The analysis may further include using machine vision to identify elements in the unstructured data. As an example, for an image of a receipt, machine vision may be utilized to identify information related to a transaction noted in the receipt such as price, location, date, buyer, seller, and the like.

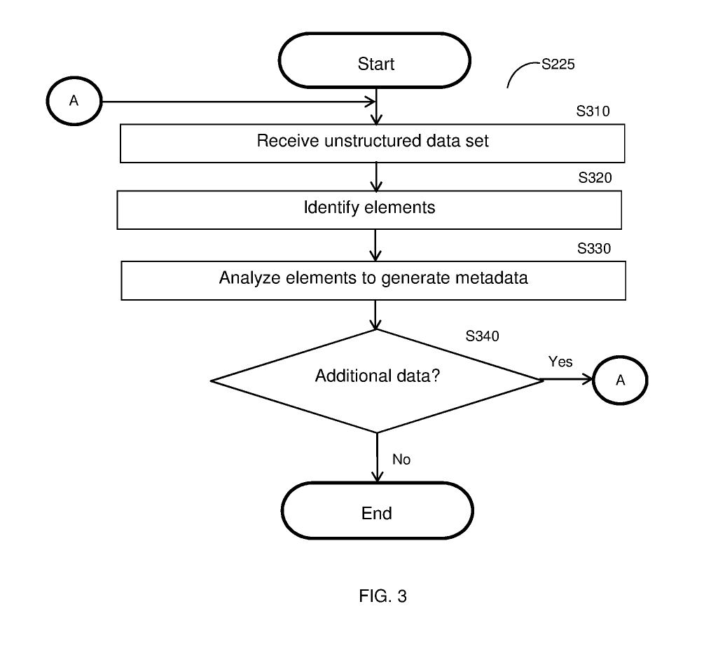

At S225, based on the analysis, metadata may be generated. The metadata generation may be based on the identified elements such that the generated metadata includes information related to the activity. Generation of metadata based on analysis of unstructured data is described further herein below with respect to FIG. 3.

At S230, based on the metadata, a report containing structured data corresponding to the unstructured data is identified. The report may be identified based on, e.g., identification of common or related strings between the structured data of the identified report and the metadata. Specifically, any or all of the metadata may be utilized as queries for searching structured data stored respective of each report in the ERP system.

In a further embodiment, identifying the report may further include disambiguation of the structured data in reports of the ERP system. For example, in a field related to the destination of a trip, the structured data for the field may be any of: “China,” “Shanghai,” “Flight to China,” “Chyna” (i.e., a typographical error for “China”), and so on. Disambiguation of such varying versions of the same or similar information may all result in the outcome for destination as “China.” The disambiguation may be based on, but not limited to, the structure of the data (e.g., data in a field “Destination” may be disambiguated based on names of locations), dictionaries, algorithms, thesauruses, and the like. In yet a further embodiment, if disambiguation is unsuccessful, a notification may be generated and sent to a user (e.g., a user of the user device 180), prompting the user to provide further clarification.

At S240, the structured data in the identified report is analyzed based on the metadata.

The analysis may include, but is not limited to, comparing the metadata to the structured data. The comparison may further include matching the structured data to the metadata.

In an embodiment, the comparison may be utilized to validate the unstructured data analysis. Specifically, it may be determined whether results of the analysis are accurate by determining whether each element identified in the unstructured data set matches structured data in a corresponding field of the report. If any of the elements do not match structured data in the corresponding fields, a user may be prompted for confirmation of the correct information. As a non-limiting example, an image of a receipt including a total price of $250.00 is analyzed, metadata including the $250.00 price is generated, and a report corresponding to the receipt is identified. The report indicates a total expense of $2,500.00. It is determined that the unstructured data analysis may be at least partially invalid, and an employee of the organization may be prompted to confirm the actual price.

At S250, it is determined whether the structured data in the identified report matches the metadata and, if so, execution continues with S260; otherwise, execution continues with S270. Whether the structured data matches the metadata may be based on, for example, a predetermined threshold.

At S260, upon determining that the identified report matches the metadata, it is determined that the report matches the unstructured data and the unstructured data set is stored in a database.

At optional S270, a notification may be generated and sent. The notification may be sent to a user device (e.g., the user device 180). If the matching was successful, the notification may indicate that the unstructured data set has been verified. If there was a mismatch, the notification may indicate that the unstructured data set was not verified.

At S280, it is determined whether additional unstructured data sets have been received and, if so, execution continues with S210; otherwise, execution terminates.

As a non-limiting example, an image of a receipt related to a purchase is received as an unstructured data set from an ERP system. The receipt is analyzed using machine vision techniques. Based on the machine vision analysis, elements shown in the image are identified. The identified elements include a date of “Mar. 4, 2015,” a time of “1:00 PM,” a purchase of “3” units of “printer ink,” a seller of “Office Supply Co.,” a company credit card number “1111 2222 3333 4444,” and a location of “Venice, Italy.” Metadata is generated indicating the information of the identified elements.

Based on the metadata, a report corresponding to the receipt shown in the image is identified using any of the metadata as a search query. The identified report is a fillable form including data provided via user inputs. Specifically, in this example, the report is identified based on the metadata indicating the date and time of the use of company credit card number 1111 2222 3333 4444. To identify the report, the structured data in a plurality of reports of an ERP system is analyzed and or disambiguated. For the identified report, one element, “Venice, Litaly,” included in the report is disambiguated as referring to “Venice, Italy.”

The structured data in the report is compared to the metadata to determine whether the structured data matches the metadata. It is determined that the structured data matches the metadata above a predefined threshold. Accordingly, it is determined that the receipt shown in the image is verified and a notification may be generated. The receipt image may be stored in a database and associated with the identified report.

FIG. 3 is an example flowchart S225 illustrating a method for generating metadata based on unstructured data according to an embodiment. In an embodiment, the method may be performed by a verification system (e.g., the verification system 120).

At S310, an unstructured data set is received. At S320, elements in the unstructured data set are identified. The elements may be identified based on an analysis of the unstructured data set via an OCR processor (e.g., the OCR processor 150). The elements may include, but are not limited to, characters and/or strings related to an activity. As an example, the elements may include printed data appearing in an expense receipt related to a business activity. Such printed data may include, but is not limited to, date, time, quantity, name of seller, type of seller business, value added tax payment, type of product purchased, payment method registration numbers, and the like.

At S330, the identified elements are analyzed to generate metadata for the activity associated with the unstructured data. The metadata may include, but is not limited to, characters and/or strings associated with an activity. To this end, the analysis may include identifying characters and/or strings in the unstructured data. The analysis may further include disambiguation of identified strings. The identified characters and/or strings may be filtered based on relevance to one or more parameters.

In another embodiment, S330 may further include disambiguating the unstructured data. The metadata may be generated based on the disambiguated unstructured data. The disambiguation may be based on, but not limited to, a file name of the unstructured data set, dictionaries, algorithms, thesauruses, and the like. As an example, for an image in a file titled “Purchase Receipt,” a string “$300.00” character on the same line as the string “Total Price” may be utilized to generate metadata indicating that the purchase price was $300.00. As another example, the string “Drance” may be disambiguated based on a dictionary to result in metadata indicating that a location associated with the unstructured data set is France.

At S340, it is checked whether additional unstructured data sets have been received and, if so, execution continues with S310; otherwise, execution terminates.

It should be noted that the embodiments described herein above with respect to data in ERP systems is described as structured data merely for simplicity purposes and without limitations on the disclosed embodiments. Semi-structured data may be used equally without departing from the scope of the disclosure. Additionally, the data may be stored in any databases or other storage units communicatively connected to systems other than ERP systems. It should further be noted that the embodiments described herein above with respect to FIGS. 2 and 3 are discussed with respect to FIG. 1 merely for example purposes and without limitation on the disclosed embodiments.

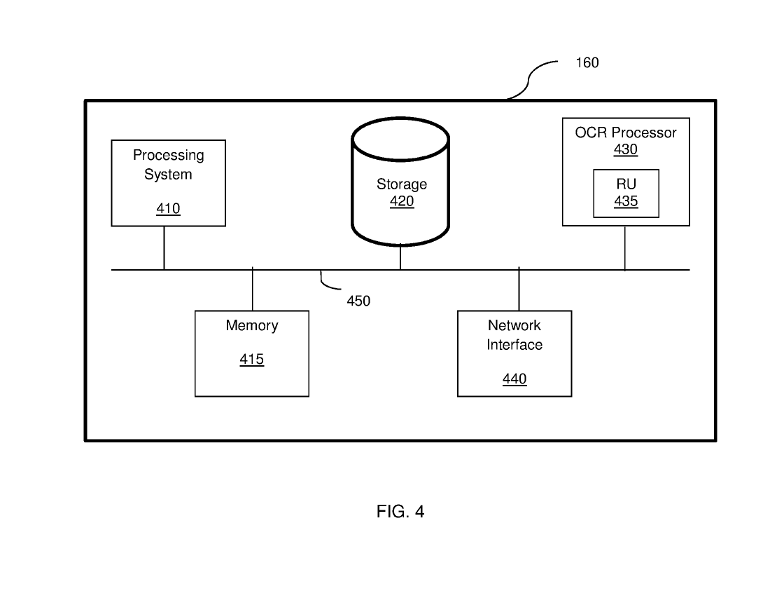

FIG. 4 shows an example block diagram of the verification system 120 implemented according to one embodiment. The verification system 120 includes a processing system 410 coupled to a memory 415, a storage 420, an optical character recognition(OCR) processor 430, and a network interface 440. In an embodiment, the components of the verification system 120 may be communicatively connected via a bus 450.

The processing system 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 415 may be volatile (e.g., RAM, etc.), non-volatile (e.g., ROM, flash memory, etc.), or a combination thereof. In one configuration, computer readable instructions to implement one or more embodiments disclosed herein may be stored in the storage 420.

In another embodiment, the memory 415 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system 410 to perform the various processes described herein. Specifically, the instructions, when executed, cause the processing system 410 to perform an on-demand authorization of access to protected resources, as discussed hereinabove.

The storage 420 may be magnetic storage, optical storage, and the like, and may be realized, for example, as flash memory or other memory technology, CD-ROM, Digital Versatile Disks (DVDs), or any other medium which can be used to store the desired information.

The OCR processor 430 may include, but is not limited to, a feature and/or pattern recognition unit (RU) 435 configured to identify patterns and/or features in unstructured data sets. Specifically, in an embodiment, the OCR processor 430 is configured to identify at least characters in the unstructured data.

The storage 420 may also store metadata generated based on analyses of unstructured data by the OCR processor 430. In a further embodiment, the storage 420 may further store queries generated based on the metadata.

The network interface 440 allows the verification system 120 to communicate with the ERP system 160 for the purpose of, for example, retrieving reports, data for verification, and/or sending notifications of mismatches between reports and unstructured data sets. Additionally, the network interface 440 allows the verification system 120 to communicate with the ERP system 160 and/or a user device (not shown) in order to send notifications regarding verification of data and/or prompts for clarification or confirmation of information.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for verifying enterprise resource planning data, comprising:
analyzing, via an optical recognition processor, an unstructured data set;
generating, based on the analysis of the unstructured data set, metadata;
identifying a report including at least partially structured data corresponding to the unstructured data set;
analyzing, based on the metadata, the identified report to determine whether the unstructured data set matches the identified report; and
determining that the unstructured data set is verified, when it is determined that the unstructured data set matches the identified report.

2. The method of claim 1, wherein identifying the report including the corresponding at least partially structured data further comprises:
generating, based on the metadata, at least one query; and
querying, using the at least one generated query, an enterprise resource planning system, wherein the report is identified based on the at least one generated query.

3. The method of claim 2, wherein identifying the report including the corresponding at least partially structured data further comprises:
disambiguating the at least partially structured data.

4. The method of claim 1, wherein analyzing the identified report further comprises:
comparing the generated metadata to the at least partially structured data.

5. The method of claim 4, wherein the unstructured data set matches the identified report when the generated metadata matches the at least partially structured data above a predefined threshold.

6. The method of claim 1, further comprising:
generating a notification based on the verification determination.

7. The method of claim 1, wherein generating the metadata further comprises:
disambiguating unstructured data of the unstructured data set, wherein the metadata is generated based on the disambiguation of the unstructured data set.

8. The method of claim 7, wherein the analysis of the unstructured data set further comprises:
identifying at least one element in the unstructured data related to an activity, wherein the metadata is generated based on the identified at least one element.

9. The method of claim 1, wherein the unstructured data set includes at least one image.

10. A non-transitory computer readable medium having stored thereon instructions for causing one or more processing units to execute the method according to claim 1.

11. A system for verifying enterprise resource planning data, comprising:
an optical recognition processor for analyzing unstructured data;
a processing unit; and
a memory, the memory containing instructions that, when executed by the processing unit, configure the system to:
analyze, by the optical recognition processor, an unstructured data set;
generate, based on the analysis of the unstructured data set, metadata;
identify a report including at least partially structured data corresponding to the unstructured data set;
analyze, based on the metadata, the identified report to determine whether the unstructured data set matches the identified report; and
determine that the unstructured data set is verified, when it is determined that the unstructured data set matches the identified report.

12. The system of claim 11, wherein the system is further configured to:
generate, based on the metadata, at least one query; and
query, using the at least one generated query, an enterprise resource planning system, wherein the report is identified based on the at least one generated query.

13. The system of claim 12, wherein the system is further configured to:
disambiguate the at least partially structured data.

14. The system of claim 11, wherein the system is further configured to:
compare the generated metadata to the at least partially structured data.

15. The system of claim 14, wherein the unstructured data set matches the identified report when the generated metadata matches the at least partially structured data above a predefined threshold.

16. The system of claim 11, wherein the system is further configured to:
generate a notification based on the verification determination.

17. The system of claim 11, wherein the system is further configured to:
disambiguate unstructured data of the unstructured data set, wherein the metadata is generated based on the disambiguation of the unstructured data set.

18. The system of claim 17, wherein the system is further configured to:
identify at least one element in the unstructured data related to an activity, wherein the metadata is generated based on the identified at least one element.

19. The system of claim 11, wherein the unstructured data set includes at least one image.
